(19) United States
(12) Patent Application Publication
(10) Pub. No.: US 2008/0240240 A1
(43) Pub. Date: Oct. 2, 2008

(54) MOVING PICTURE CODING APPARATUS AND METHOD

(75) Inventor: Tomoya Kodama, Kawasaki-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/047,601

(22) Filed: Mar. 13, 2008

(30) Foreign Application Priority Data
Mar. 29, 2007 (JP) 2007-087193

(51) Int. Cl. H04N 7/32

(52) U.S. Cl. 375/240.14; 375/E07.243

(57) ABSTRACT

A moving picture coding apparatus includes a computing unit configured to compute a distortion robustness indicating degree of imperceptibility of coding distortion in a region to be coded in an input picture, an estimation unit configured to estimate coding distortions based on a first prediction residual of an intra predicted picture, and a second prediction residual of an inter predicted picture, an estimation unit configured to estimate code lengths to be generated when coding the first and second prediction residuals, a computing unit configured to compute coding costs of the first and second prediction residuals by weighted addition of the coding distortions and code lengths so that effect of the code lengths more increases than that of the coding distortions as the distortion robustness increases, a selection unit configured to select one of the first and second prediction residuals for which the coding cost is minimized.

### CROSS-REFERENCE TO RELATED APPLICATIONS

This application is based upon and claims the benefit of priority from prior Japanese Patent Application No. 2007-087193, filed Mar. 29, 2007, the entire contents of which are incorporated herein by reference.

### BACKGROUND OF THE INVENTION

1. Field of the Invention

The present invention relates to a moving picture coding apparatus and method which selects the optimum prediction mode and motion vector using rate-distortion optimization.

2. Description of the Related Art

With MPEG-4 AVC/H.264, which is recently becoming the primary international standard for coding of moving pictures, a plurality of prediction modes has been set up in motion-compensated inter-frame prediction and intra-frame prediction. The optimum one is selected from these prediction modes for each block of an input picture to provide coding. With the inter prediction, the optimum motion vector is selected from among a plurality of candidate motion vectors to perform motion compensation. One known evaluation method for selecting the prediction mode and the motion vector is rate-distortion optimization.

In JP-A 2003-230149 (KOKAI), as a specific evaluation function for rate-distortion optimization concerning prediction modes, the following function is disclosed:

C=D+λR (1)

where D is the distortion between the original and the reconstructed macroblocks when coding is performed in a certain prediction mode, R is the length (rate) of codewords generated when coding is performed in the prediction mode, C is the coding cost in the prediction mode, and λ is a Lagrange multiplier.

As the distortion D, the sum of squared differences (SSD) between an original picture and its reconstructed picture is used. A prediction mode for which the coding cost is minimized is selected as the optimum prediction mode. In addition, JP-A No. 2006-94801 (KOKAI) discloses a method to correct the coding cost C according to activities of input images.

A specific method of determining the Lagrange multiplier has been proposed in an article entitled “Lagrange Multiplier Selection in Hybrid Video Coder Control” by Thomas Wiegand and Bernd Girod, ICIP 2001, vol. 3, pp. 542-545, October 2001 (related art 1). In related art 1, the Lagrange multiplier λmode for making a selection among prediction modes is determined by:

λ_{mode}=0.85Q² (2)

where Q represents the quantization step size.

In related art 1, a similar evaluation function to expression 1 is also used in estimating the optimum motion vector from among a number of candidate motion vectors. In related art 1, the Lagrange multiplier λmotion for estimating a motion vector is determined by:

λₘₒₜᵢₒₙ=\sqrt{λ_{mode}} (3)

In estimating the motion vector, the sum of absolute difference (SAD) as the coding distortion D in expression 1 is used.

According to expressions 2 and 3 proposed in related art 1, the Lagrange multipliers λmode and λmotion depend only upon the quantization step size Q. Therefore, when the quantization step size Q is large, the Lagrange multipliers λmode and λmotion increase excessively, which might cause the code length, R, to be regarded as important more than necessary in computing the coding cost C. Regarding the code length, R, as important more than necessary in computing the coding cost C involves a problem particularly in pictures for which coding errors (distortion) between reconstructed pictures and original pictures are perceptible, which might cause perceptual degradation of reconstructed pictures.

### BRIEF SUMMARY OF THE INVENTION

According to an aspect of the present invention, there is provided a moving picture coding apparatus comprising: a first computing unit configured to compute a distortion robustness indicating degree of imperceptibility of coding distortion in a region to be coded in an input picture; an intra prediction unit configured to perform intra-frame prediction on the region to be coded to obtain an intra predicted picture; an inter prediction unit configured to perform inter-frame prediction on the region to be coded to obtain an inter predicted picture; a first estimation unit configured to estimate a first coding distortion based on a first prediction residual between the intra predicted picture and the region to be coded, and estimate a second coding distortion based on a second prediction residual between the inter predicted picture and the region to be coded; a second estimation unit configured to estimate a first code length to be generated when coding the first prediction residual, and estimate a second code length to be generated when coding the second prediction residual; a second computing unit configured to compute a first coding cost of the first prediction residual by weighted addition of the first coding distortion and the first code length so that effect of the first code length more increases than that of the first coding distortion as the distortion robustness increases, and compute a second coding cost of the second prediction residual by weighted addition of the second coding distortion and the second code length so that effect of the second code length more increase than that of the second coding distortion as the distortion robustness increases; a selection unit configured to select one of the first prediction residual and second prediction residual for which the coding cost is minimized to obtain selected prediction residual; and an entropy coding unit configured to code the selected prediction residual.

According to another aspect of the present invention, there is provided a moving picture coding apparatus comprising: a first computing unit configured to compute a distortion robustness indicating degree of imperceptibility of coding distortion in a region to be coded in an input picture; a motion vector forming unit configured to form candidate motion vectors between the region to be coded and a reference picture; a first estimation unit configured to estimate coding distortions if the region to be coded is motion-compensated with each of the candidate motion vectors; a second estimation unit configured to estimate code lengths to be generated when coding each of the candidate motion vectors; a second computing unit configured to compute coding costs corresponding to each of the candidate motion vectors by weighted addition of the coding distortions and the code lengths so that effect of the code lengths more increase than that of the coding distortions as the distortion robustness increases; a detection unit configured to detect one of the candidate motion vectors for which the coding cost is minimized to obtain detected motion vector; an inter prediction unit configured to perform inter prediction on the region to be coded using the detected motion vector to obtain an inter predicted picture; and an entropy coding unit configured to code the prediction residual for the inter predicted picture of the region to be coded.

According to the present invention, there is provided a moving picture coding apparatus which is adapted to suppress the perceptual degradation of reconstructed pictures even if the quantization step size is large.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a block diagram of a moving picture coding apparatus according to an embodiment;

FIG. 2 shows the manner in which one macroblock MB is divided into four blocks blk0 to blk3;

FIG. 3 shows the manner in which one macroblock MB is divided into sixteen blocks blk0 to blk15;

FIG. 4 is a graphical representation of expression 9 in which the distortion robustness rob is shown on the horizontal axis and the Lagrange multiplier λmode is shown on the vertical axis;

FIG. 5 is a diagram for use in explanation of a problem with determining the Lagrange multipliers λmode on the basis of the quantization step size Q alone;

FIG. 6 shows changes of a macroblock to be coded shown in FIG. 5 from frame to frame;

FIG. 7 shows the motion-compensated residual in correspondence with FIG. 6;

FIG. 8 shows an example of deriving a predictive motion vector MVpred; and

FIG. 9 is a diagram for use in explanation of search for a candidate motion vector MVcan.

### DETAILED DESCRIPTION OF THE INVENTION

An embodiment of the present invention will be described hereinafter with reference to the accompanying drawings.

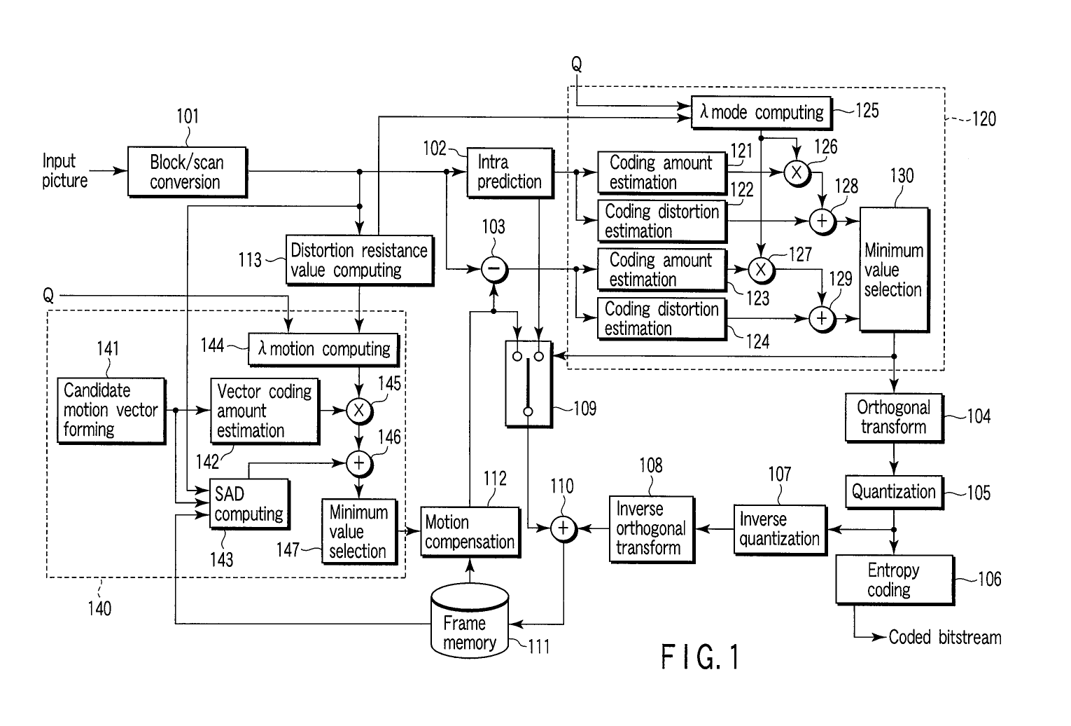

As shown in FIG. 1, a moving picture coding apparatus according to an embodiment of the present invention includes a block/scan converter 101, an intra prediction unit 102, a subtracter 103, an orthogonal transform unit 104, a quantization unit 105, an entropy coding unit 106, an inverse quantization unit 107, an inverse orthogonal transform unit 108, a selector 109, an adder 110, a frame memory 111, a motion compensation unit 112, a distortion robustness computing unit 113, a mode selection unit 120, and a motion vector estimation unit 140.

The mode selection unit 120 includes a coding amount estimation unit 121, a coding distortion estimation unit 122, a coding amount estimation unit 123, a coding distortion estimation unit 124, a λmode computing unit 125, a multiplier 126, a multiplier 127, an adder 128, an adder 129, and a minimum value selector 130. The motion vector estimation unit 140 includes a candidate motion vector forming unit 141, a vector coding amount estimation unit 142, a coding distortion estimation unit 143, a λmotion computing unit 144, a multiplier 145, an adder 146, and a minimum value selector 147.

An input picture (original picture) is segmented into macroblocks by the block/scan converter 101 and then input to the intra prediction unit 102, the subtracter 103, the distortion robustness computing unit 112, and the vector coding amount estimation unit 142. The input picture segmented into macroblock is hereinafter referred to simply as the blocked picture.

The intra prediction unit 102 performs intra prediction of pixels in the blocked picture from the block/scan converter 101 on the basis of their respective surrounding blocked pictures already coded. The intra predicted block is input to the selector 109. A first prediction residual signal corresponding to the difference between the intra predicted block and the original block is input to the mode selection unit 120.

The subtracter 103 calculates the difference between an inter predicted block from the motion compensation unit 112 and the original block from the block/scan converter 101 to obtain a second prediction residual signal, which is in turn applied to the mode selection unit 120.

The orthogonal transform unit 104 performs an orthogonal transform, such as a discrete cosine transform (DCT), of a prediction residual signal in the optimum prediction mode selected by the mode selection unit 120 to obtain the orthogonal transform coefficients. The quantization unit 105 quantizes the orthogonal transform coefficients output from the orthogonal transform unit 104.

The entropy coding unit 106 performs entropy coding, such as variable-length coding, arithmetic coding, etc., of the orthogonal transform coefficients quantized by the quantization unit 105 to output a coded bitstream. The entropy coding unit 106 also performs coding of motion compensation parameters, such as a motion vector estimated by the motion vector estimation unit 140, and mode information indicating a prediction mode selected by the mode selection unit 120. These are generally referred to as side information. From the entropy coding unit 106, the coded bitstream is output with the coded side information appended.

The inverse quantization unit 107 performs inverse quantization on the quantized orthogonal transform coefficients from the quantization unit 105. The inverse orthogonal transform unit 108 performs an inverse orthogonal transform (for example, an inverse discrete cosine transform [IDCT]) on the orthogonal transform coefficients from the inverse quantization unit 107 to decode the prediction residual signal. The selector 109 selects either an intra predicted signal from the intra prediction unit 102 or an inter predicted signal from the motion compensation unit 112 according to the result of selection by the mode selection unit 120. The adder 110 adds together the prediction residual signal from the inverse orthogonal transform unit 108 and the predicted signal selected by the selector 109 to form a locally decoded picture.

The frame memory 111 is stored with the locally decoded picture from the adder 110 as a reference picture. The frame memory 111 may be preceded by a deblocking filter to remove block distortion from the locally decoded picture.

The motion compensation unit 112 subject the reference picture from the frame memory 111 to motion compensation using the motion vector from the motion vector estimation unit 140 to produce a motion-compensated inter predicted picture, which is in turn input to the subtracter 103 and the selector 109.

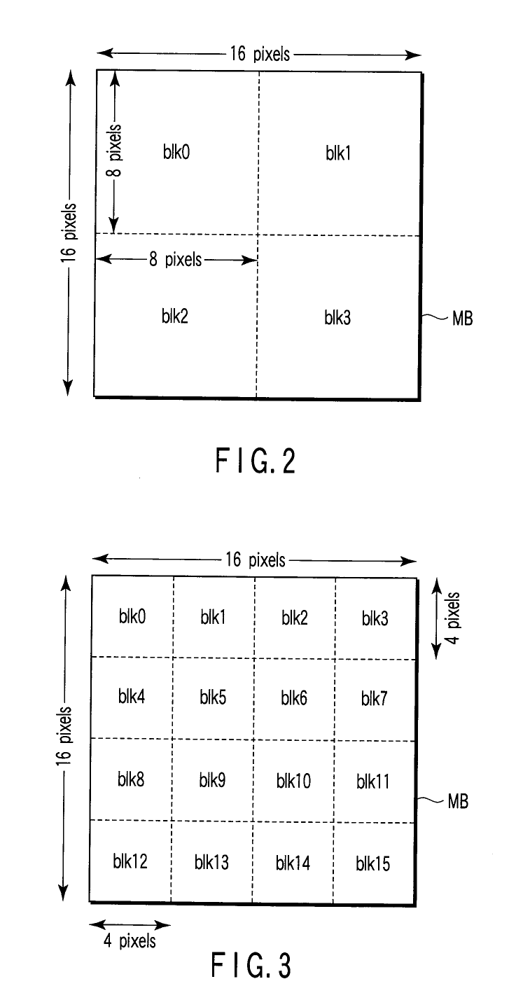

The distortion robustness computing unit 113 computes from pixel values of the input blocked picture from the block/scan conversion unit 101 a distortion robustness rob which is used in deriving λmode and λmotion in the λmode and λmotion computing units 125 and 144. The distortion robustness computing unit 113 computes the minimum value of the variances of pixel values of such four blocks blk0 to blk3 into which the macroblock MB is divided as shown in FIG. 2. The distortion robustness rob in this case is given by:

$$rob = min ( {var}_{x} ) \\ {var}_{x} = {\sum }_{p ∈ {blk}_{x}} {( p - \overline{{p}_{x}} )}^{2} \\ \overline{{p}_{x}} = \frac{1}{64} {\sum }_{p ∈ {blk}_{x}}^{ } p \qquad ( 4 )$$

where p is the pixel value. In a region where pixel values are flat, the values of surrounding pixels change smoothly, therefore, the coding distortion D tends to become perceptible. Thus, expression 4 provides a distortion robustness rob that indicates the degree of imperceptibility of the coding distortion D in the macroblock MB.

The distortion robustness computing unit 113 may compute the minimum value of average brightness values of pixels of the respective blocks blk0 to blk3 as the distortion robustness rob. The distortion robustness rob in this case is given by:

$$rob = min ( {brightness}_{x} ) \\ {brightness}_{x} = \frac{1}{64} {\sum }_{p ∈ {blk}_{x}}^{ } p \qquad ( 5 )$$

where p is the pixel value. In a region where the average brightness is low (dark portion), the coding distortion D tends to become perceptible. Thus, expression 5 provides a distortion robustness rob that indicates the degree of imperceptibility of the coding distortion D in the macroblock MB.

The distortion robustness computing unit 113 may computes the minimum value of dynamic ranges of pixel values of the respective blocks blk0 to blk3 as the distortion robustness rob. In this case, the distortion robustness rob is given by:

rob=min(d_rangeₓ)

d_rangeₓ=(pₘₐₓ−pₘᵢₙ|pεblkₓ) (6)

where p is the pixel value, Pmax is the maximum value of the pixel values, and Pmin is the minimum value of the pixel values. In a region where the dynamic range is narrow, the coding distortion D tends to become perceptible. Thus, expression 6 provides a distortion robustness rob that indicates the degree of imperceptibility of the coding distortion D in the macroblock MB.

In view of a region of interest (ROI), the distortion robustness computing unit 113 may compute the distortion robustness rob on the basis of whether or not the blocks blk0 to blk3 have a specific hue, such as a skin color. In this case, the distortion robustness rob is computed by:

$$\begin{matrix}r o b = \{ \begin{matrix}0 & if ∃ x ( {\overline{p}}_{x} ∈ R O I ) \\ 1 & else\end{matrix} \\ {\overline{p}}_{x} = ( \overline{{p}_{Yx}} , \overline{{p}_{Ux}} , \overline{{p}_{Vx}} ) \\ {\overline{p}}_{Yx} = \frac{1}{64} {\sum }_{p ∈ b l {k}_{x}} {p}_{Y} \\ {\overline{p}}_{Ux} = \frac{1}{16} {\sum }_{p ∈ b l {k}_{x}} {p}_{U} \\ {\overline{p}}_{Vx} = \frac{1}{16} {\sum }_{p ∈ b l {k}_{x}} {p}_{V}\end{matrix} \qquad ( 7 )$$

where pY is the brightness value, pU and pV are color differences, and ROI is the region of interest. Herein after, an explanation is given of an example of a region of interest when a skin color is used as the region of interest. According to the Handbook of Hue Science (second edition) published by Tokyo University Publications Association (related art 2), the hue (H) in the HSV color specification system has values in the range of 0 to 100 and ranges of hue H=1.0-7.0, saturation S=16.0-19.0 and lightness V=1.0-5.0 have been specified as a skin color chart by Japan Color Laboratory. According to Japanese Patent No. 3863809, when hue H, saturation S and lightness V are specified in the ranges of [0, 2π], [0, 1] and [0, 1], respectively, the skin color is defined such that 0.11<H<0.22 and 0.2<S<0.5. These ranges of hue and saturation are merely exemplary in the case where the skin color is used as a region of interest and do not limit the range of the skin color in this embodiment.

When the resolution of input images is relatively low, they makes up a large percentage of the entire picture (the entire picture is made up of a small number of macroblocks), which leads to an increase in the number of objects which can be included in one macroblock. In such a case, the macroblock MB may be further divided into fine blocks blk0 to blk15 as shown in FIG. 3 to compute the distortion robustness rob. In addition, some of the above expressions may be combined to compute the distortion robustness rob.

The mode selection unit 120 selects the optimum prediction mode on the basis of the quantization step size Q, the first prediction residual signal from the intra prediction unit 102, the second prediction residual signal from the subtracter 103, and the distortion robustness rob from the distortion robustness computing unit 113.

The coding amount estimation unit 121 estimates the code length, R, generated when the first prediction residual signal is coded. The coding amount estimation unit 123 estimates the code length, R, generated when the second prediction residual signal and the motion vector are coded.

The coding distortion estimation unit 122 computes from the first prediction residual signal input to it the sum of squared differences SSD as the coding distortion D in each prediction mode. Likewise, the coding distortion estimation unit 124 computes from the second prediction residual signal input to it the sum of squared differences SSD as the coding distortion D in each prediction mode. The sum of squared differences SSD is computed by:

$$SSD = {\sum }_{x , y ∈ MB}^{ } {( Ldec ( x , y ) - cur ( x , y ) )}^{2} \qquad ( 8 )$$

where Ldec(x, y) are pixel values at coordinates (x, y) in a locally decoded picture when the corresponding macroblock is coded in each prediction mode and cur(x, y) are pixel values at coordinates (x, y) in the original picture.

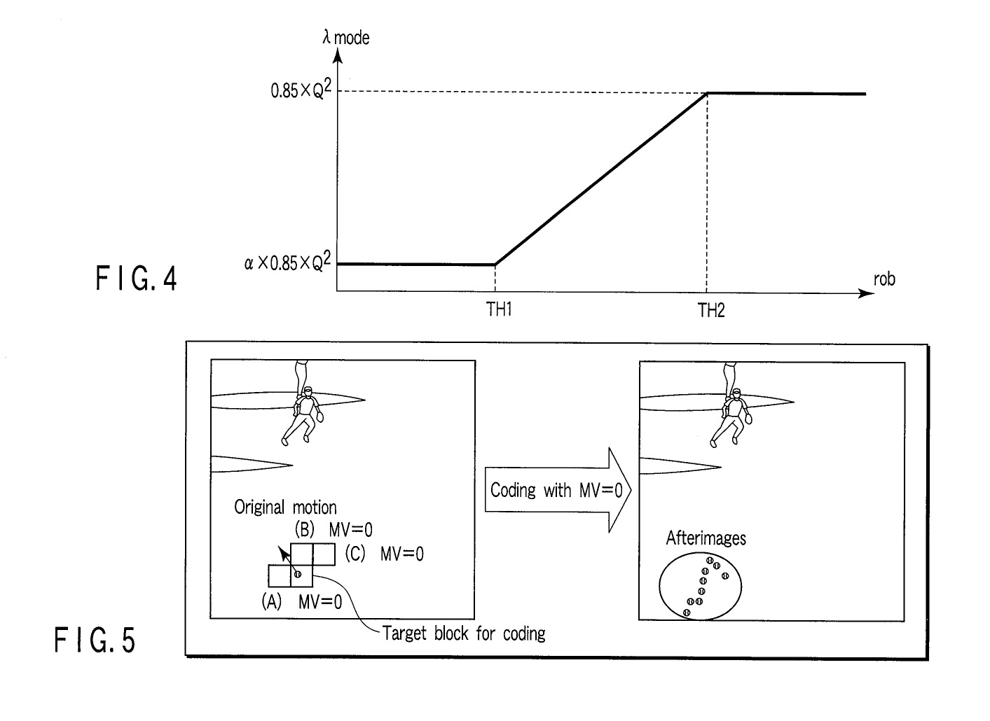

The λmode computing unit 125 computes the Lagrange multiplier λmode for prediction mode selection according to this embodiment. The Lagrange multiplier λmode is derived using the quantization step size Q and the distortion robustness rob as follows:

$${λ}_{mode} = min ( \begin{matrix}0.85 {Q}^{2} , \\ max ( \begin{matrix}0.85 α {Q}^{2} , \\ \frac{0.85 ( 1 - α ) {Q}^{2}}{{TH}_{2} - {TH}_{1}} ( rob - {TH}_{1} ) + 0.85 α {Q}^{2}\end{matrix} )\end{matrix} ) \qquad ( 9 )$$

where α is a constant from zero to less than 1 and TH1 and TH2 are first and second thresholds for the distortion robustness rob, TH1 being smaller than TH2. According to expression 9 is obtained such a Lagrange multiplier λmode as increases monotonically with the distortion robustness rob. As shown in FIG. 4, when the distortion robustness rob is less than the first threshold TH1, the Lagrange multiplier λmode is fixed at 0.85αQ². When the distortion robustness rob lies in the range from TH1 to less than TH2, the Lagrange multiplier λmode increases linearly. When the distortion robustness rob is equal to or more than the second threshold TH2, the Lagrange multiplier λmode is fixed at 0.85Q². It should be noted that expression 9 is merely an example of a function for deriving the Lagrange multiplier λmode according to this embodiment and is therefore not restrictive. That is, it is only required that the Lagrange multiplier λmode increase monotonically with the distortion robustness rob.

Next, reference is made to FIGS. 5, 6 and 7 to explain a problem with determining the Lagrange multiplier λmode on the basis of the quantization step size Q alone.

The left-hand portion of FIG. 5 shows a frame of video of baseball captured by a fixed camera. Consider coding of a macroblock MB containing a ball as an object in the left-hand portion of FIG. 5. As shown in the left-hand portion of FIG. 5, in the macroblock to be coded, almost the entire region is occupied by ground and the region occupied by the ball is small. Therefore, the difference from the corresponding macroblocks MB in the same location in other frames virtually represents only the ball. Since the region corresponding to the ball is small, the total differences between the corresponding macroblocks will fall into a relatively small value even if the motion vector MV is set to zero. That is, even if such a motion vector as to compensate accurately the movement of the ball (to minimize the coding distortion D) is selected, the coding distortion D is little changed as compared with a case where the motion vector is set to zero.

Since there is no moving object besides the ball in the left-hand portion of FIG. 5, on the other hand, the motion vectors MV associated with macroblocks MB surrounding the macroblock to be coded are set to zero. In MPEG-4 AVC/H.264, with reference to a predictive motion vector MVpred determined by motion vectors MV associated with macroblocks MB surrounding a macroblock to be coded, the difference between the predictive motion vector MVpred and a searched motion vector is coded. In this example, since the motion vectors MV of the macroblocks surrounding the macroblock to be coded are all zero, the predictive motion vector MVpred is also zero. Thus, the code length R associated with moving vectors when the motion vectors MV are set to zero becomes minimized.

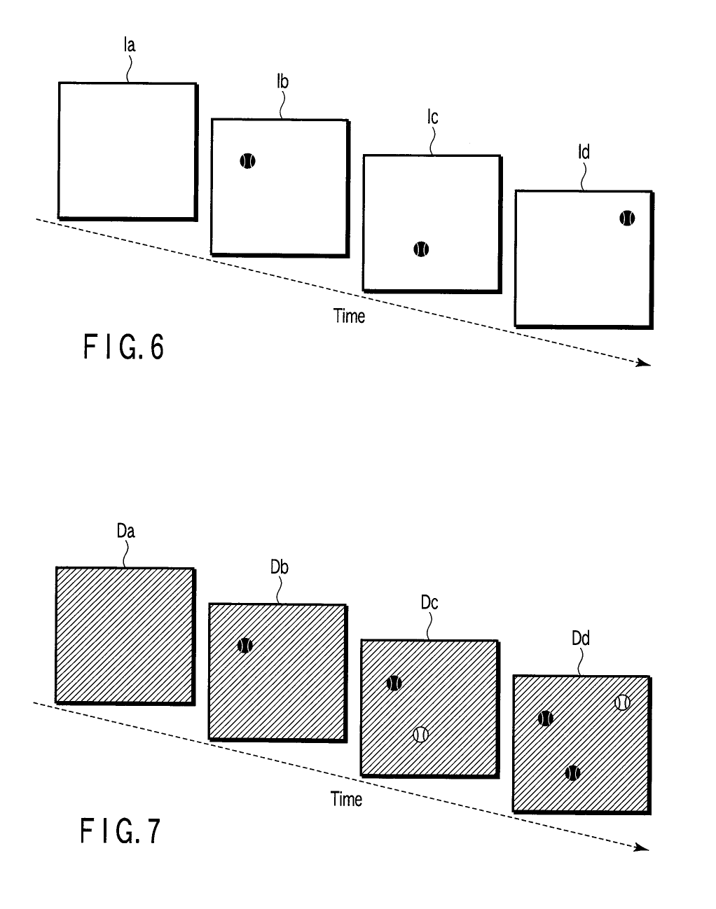

When the coding cost C is computed under the above conditions, the above-mentioned Lagrange multipliers λmode and λmotion become large particularly when the quantization step size Q is large. Since the generated code length R is regarded as important in computing the coding cost C, the motion vector MV tends to be selected to be zero (=MVpred) in order to prevent the code length R from increasing. Suppose here that the macroblock to be coded changes as shown in FIG. 6 and is coded with its associated motion vector MV as zero in every frame. Assuming that an original picture Ia is an I slice and original pictures Ib, Ic and Id are P slices, the original picture Ia is coded on the basis of intra prediction and the locally decoded picture Ia′ is recorded in the frame memory 111. Next, the original picture Ib is predicted from the locally decoded picture Ia′ to determine a motion-compensated residual Db shown in FIG. 7. In the frame memory 111 is recorded the locally decoded picture Ib′ (=Ia′+Db+Nb) added with coding noise Nb resulting from quantization of the motion-compensated residual Db in the quantization unit 105. Since the motion vector MV associated with the locally decoded picture Ia′ is zero, the coding noise Nb is concentrated in the location of the ball in the motion-compensated residual Db. Next, the original picture Ic is predicted from the locally decoded picture Ib′ to determine a motion-compensated residual Dc. In the frame memory 111 is recorded the locally decoded picture Ic′ (=Ib′+Dc+Nc) added with coding noise Nc resulting from quantization of the motion-compensated residual Dc in the quantization unit 105. Since the motion vector MV associated with the locally decoded picture Ib′ is zero, the coding noise Nb is concentrated on the ball on the right-hand side in the motion-compensated residual Dc. In addition, the coding noise Nb propagated from the locally decoded picture Ib′ is concentrated on the ball on the left-hand side in the motion-compensated residual Dc. Next, the original picture Id is predicted from the locally decoded picture Ic′ to determine a motion-compensated residual Dd. In the frame memory 111 is recorded the locally decoded picture Id′ (=Ic′+Dd+Nd) added with coding noise Nd resulting from quantization of the motion-compensated residual Dd in the quantization unit 105. Since the motion vector MV associated with the locally decoded picture Ic′ is zero, the coding noise Nd is concentrated on the ball on the right-hand side in the motion-compensated residual Dd. In addition, the coding noises Nb and Nc propagated from the locally decoded picture Ic′ are concentrated on the balls on the left-hand side and at the center in the motion-compensated residual Dd.

Thus, if the Lagrange multipliers λmode and λmotion are determined on the basis of the quantization step size Q alone, the motion-compensated residual will not be coded sufficiently when the quantization step size Q is large. As a result, afterimages of the ball will be produced as shown in the right-hand portion of FIG. 5, which causes or threatens perceptual degradation. On the other hand, adjusting the Lagrange undermined multipliers λmode and λmotion so as to increase monotonically with the distortion robustness rob of a macroblock to be coded as in this embodiment allows the priority between the coding distortion D and the code length R to be changed adaptively in deriving the coding cost C on the basis of the degree of perceptibility or imperceptibility of the coding distortion. Thus, the perceptual degradation can be suppressed.

The multipliers 126 and 127 and the adders 128 and 129 are provided to perform the following operation:

C_{mode}=SSD+λ_{mode}R (10)

where Cmode is the coding cost in the each prediction mode. That is, the multipliers 126 and 127 perform multiplication of the Lagrange multiplier λmode and the code length R in expression 10 and the adders 128 and 129 perform addition of the product output and the sum of squared differences SSD, thereby computing the coding cost Cmode.

The minimum value selector 130 selects a prediction mode for which that the coding cost Cmode from the adders 128 and 129 is minimized and then inputs the prediction residual signal in the selected prediction mode to the orthogonal transform unit 104. Although the intra and inter prediction modes have been described as if each of them were of only one type, there may be a plurality of types of intra or inter prediction modes.

The motion vector estimation unit 140 selects the optimum motion vector on the basis of the blocked picture signal from the block/scan converter 101, the reference picture signal from the frame memory 111, and the distortion robustness rob from the distortion robustness computing unit 113.

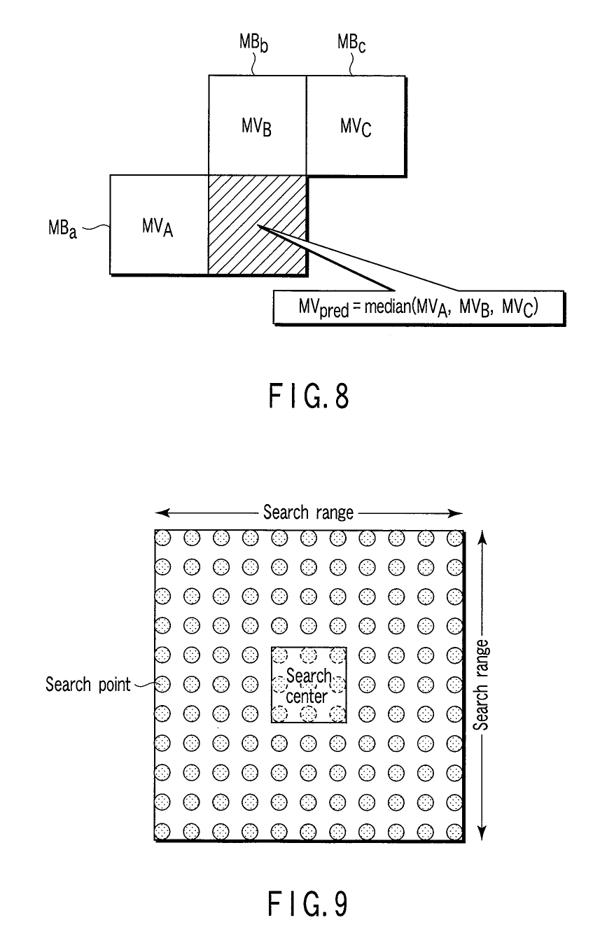

The candidate motion vector forming unit 141 forms candidate motion vectors. The candidate motion vector forming unit 141 first forms a predictive motion vector Mvpred from macroblocks surrounding a macroblock to be coded. Here, the predictive motion vector MVpred is given by, for example, the median of motion vectors MVa, MVb and MVc associated with the macroblocks MBa, MBb and MBc which are respectively located to the left of, above and to the upper right of the macroblock to be coded as shown in FIG. 8. For example, assume that MVa=(xa, ya), MVb=(xb, yb), MVc=(xc, yc), xa<xb<xc and ya<yb<yc. Then, the predictive motion vector will be given by MVpred=(xb, yb). Next, as shown in FIG. 9, the candidate motion vector forming unit 141 forms candidates of motion vector MV within a given search area with the predictive motion vector MVpred as the center and then input them as candidate motion vectors MVcan to the vector coding amount estimation unit 142 and the vector coding distortion estimation unit 143.

The vector coding amount estimation unit 142 estimates the code length Rmv generated when the each candidate motion vector MVcan from the candidate motion vector forming unit 141 is coded and then inputs it to the multiplier 145.

The vector coding distortion estimation unit 143 derives the sum of absolute differences SAD as the vector coding distortion when the reference picture is motion-compensated with the each candidate motion vector MVcan, by using the reference picture signal from the reference frame memory 111, the candidate motion vector MVcan from the candidate vector forming unit 141, and the blocked picture signal from the block/scan conversion unit 101. The SAD is given by:

$$SAD = {\sum }_{x , y ∈ MB}^{ } \vert ref ( x + {x}_{mv} , y + {y}_{mv} ) - cur ( x , y ) \vert \qquad ( 11 )$$

where ref(x, y) are pixel values at coordinates (x, y) in the reference picture, cur(x, y) are pixel values at coordinates (x, y) in the original picture, and xmv and ymv are x and y components, respectively, of the candidate motion vector MVcan. The sum of absolute differences SAD is then input to the adder 146.

The λmotion computing unit 144 computes the Lagrange multiplier λmotion for motion vector selection according to this embodiment. The Lagrange multiplier λmotion is derived from expressions 3 and 9 as follows:

$$\begin{matrix}{λ}_{motion} = \sqrt{{λ}_{mode}} \\ = \sqrt{min ( \begin{matrix}0.85 {Q}^{2} , \\ max ( \begin{matrix}0.85 α {Q}^{2} , \\ \frac{0.85 ( 1 - α ) {Q}^{2}}{{TH}_{2} - {TH}_{1}} ( rob - {TH}_{1} ) + 0.85 α {Q}^{2}\end{matrix} )\end{matrix} )}\end{matrix} \qquad ( 12 )$$

It should be noted that expression 12 is merely an example of a function for deriving the Lagrange multiplier λmotion according to this embodiment and not restrictive. That is, it is only required that the Lagrange multiplier λmotion increase monotonically with the distortion robustness rob as with the Lagrange multiplier λmode. The λmotion is then input to the multiplier 145.

The multiplier 145 and the adder 146 are provided to perform the following operation:

C(MV)=SAD+λₘₒₜᵢₒₙRₘᵥ (13)

where C(MV) is the coding cost corresponding to the candidate motion vector MVcan. That is, the multiplier 145 performs multiplication of the Lagrange multiplier λmotion and the code length R in expression 13 and the adder 145 adds together the product output and the sum of absolute differences SAD, thereby computing the coding cost C(MV).

The minimum value selection unit 147 selects a candidate motion vector MVcan for which the coding cost C(MV) from the adder 146 is minimized and then input that selected motion vector MV to the motion compensation unit 112.

As described above, the moving picture coding apparatus according to this embodiment can change adaptively the effects of the coding distortion and the code length in computing the coding cost in rate-distortion optimization by using Lagrange multipliers that monotonically increase with the distortion robustness indicating the degree of imperceptibility of coding distortion. That is, in calculation of the coding cost, the moving picture coding apparatus of this embodiment regards as important reduction of the coding distortion in a region where the coding distortion is prone to perception and the code length in a region where the coding distortion is not prone to perception. Accordingly, according to the moving picture coding apparatus of this embodiment, even when the quantization step size is large, in a region where the coding distortion is prone to perception a prediction mode and a motion vector are selected so as to reduce the coding distortion, allowing the perceptual degradation of the quality of reconstructed pictures to be suppressed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A moving picture coding apparatus comprising:
a first computing unit configured to compute a distortion robustness indicating degree of imperceptibility of coding distortion in a region to be coded in an input picture;
an intra prediction unit configured to perform intra-frame prediction on the region to be coded to obtain an intra predicted picture;
an inter prediction unit configured to perform inter-frame prediction on the region to be coded to obtain an inter predicted picture;
a first estimation unit configured to estimate a first coding distortion based on a first prediction residual between the intra predicted picture and the region to be coded, and estimate a second coding distortion based on a second prediction residual between the inter predicted picture and the region to be coded;
a second estimation unit configured to estimate a first code length to be generated when coding the first prediction residual, and estimate a second code length to be generated when coding the second prediction residual;
a second computing unit configured to compute a first coding cost of the first prediction residual by weighted addition of the first coding distortion and the first code length so that effect of the first code length more increases than that of the first coding distortion as the distortion robustness increases, and compute a second coding cost of the second prediction residual by weighted addition of the second coding distortion and the second code length so that effect of the second code length more increase than that of the second coding distortion as the distortion robustness increases;
a selection unit configured to select one of the first prediction residual and second prediction residual for which the coding cost is minimized to obtain selected prediction residual; and
an entropy coding unit configured to code the selected prediction residual.

2. The apparatus according to claim 1, wherein the first computing unit computes the distortion robustness based on a variance of pixel values contained in the region to be coded.

3. The apparatus according to claim 1, wherein the first computing unit computes the distortion robustness based on a dynamic range of pixel values contained in the region to be coded.

4. The apparatus according to claim 1, wherein the first computing unit computes the distortion robustness based on an average brightness of the region to be coded.

5. The apparatus according to claim 1, wherein the first computing unit computes the distortion robustness based on whether or not an average hue and an average saturation of the region to be coded belong to a range of skin colors.

6. The apparatus according to claim 1, wherein the second computing unit computes the first coding cost by multiplying the first code length by a weight that monotonically increases with the distortion robustness and then adding the first coding distortion to the product, and computes the second coding cost by multiplying the second code length by the weight and then adding the second coding distortion to the product.

7. A moving picture coding apparatus comprising:
a first computing unit configured to compute a distortion robustness indicating degree of imperceptibility of coding distortion in a region to be coded in an input picture;
a motion vector forming unit configured to form candidate motion vectors between the region to be coded and a reference picture;
a first estimation unit configured to estimate coding distortions if the region to be coded is motion-compensated with each of the candidate motion vectors;
a second estimation unit configured to estimate code lengths to be generated when coding each of the candidate motion vectors;
a second computing unit configured to compute coding costs corresponding to each of the candidate motion vectors by weighted addition of the coding distortions and the code lengths so that effect of the code lengths more increase than that of the coding distortions as the distortion robustness increases;
a detection unit configured to detect one of the candidate motion vectors for which the coding cost is minimized to obtain detected motion vector;
an inter prediction unit configured to perform inter prediction on the region to be coded using the detected motion vector to obtain an inter predicted picture; and
an entropy coding unit configured to code the prediction residual for the inter predicted picture of the region to be coded.

8. The apparatus according to claim 7, wherein the first computing unit computes the distortion robustness based on a variance of pixel values contained in the region to be coded.

9. The apparatus according to claim 7, wherein the first computing unit computes the distortion robustness based on a dynamic range of pixel values contained in the region to be coded.

10. The apparatus according to claim 7, wherein the first computing unit computes the distortion robustness based on an average brightness of the region to be coded.

11. The apparatus according to claim 7, wherein the first computing unit computes the distortion robustness based on whether or not an average hue and an average saturation of the region to be coded belong to a range of skin colors.

12. The apparatus according to claim 7, wherein the second computing unit computes the coding costs corresponding to each of the candidate motion vectors by multiplying the code lengths by a weight that monotonically increases with the distortion robustness and then adding the coding distortions to the product.

13. A moving picture coding method comprising:
computing a distortion robustness indicating degree of imperceptibility of coding distortion in a region to be coded in an input picture;
performing intra prediction on the region to be coded to obtain an intra predicted picture;
performing inter prediction on the region to be coded to obtain an inter predicted picture;
estimating a first coding distortion based on a first prediction residual between the intra predicted picture and the region to be coded, and estimating a second coding distortion based on a second prediction residual between the inter predicted picture and the region to be coded;
estimating a first code length generated by coding the first prediction residual, and estimating a second code length generated by coding the second prediction residual;
computing a first coding cost of the first prediction residual by weighted addition of the first coding distortion and the first code length so that effect of the first code length more increases than that of the first coding distortion as the distortion robustness increases, and computing a second coding cost of the second prediction residual by weighted addition of the second coding distortion and the second code length so that effect of the second code length more increase than that of the second coding distortion as the distortion robustness increases;
selecting one of the first prediction residual and second prediction residual for which the coding cost is minimized to obtain selected prediction residual; and
coding the selected prediction residual.
